(19) United States
(12) Patent Application Publication
(10) Pub. No.: US 2002/0113466 A1
(43) Pub. Date: Aug. 22, 2002

(54) Assembly for vehicle body, in particular cover for a motor vehicle sliding roof

(76) Inventors: Horst Bohm, Frankfurt (DE); Rainer Grimm, Frankfurt (DE)

Correspondence Address: CARLSON, GASKEY & OLDS, P.C., 400 WEST MAPLE ROAD, SUITE 350, BIRMINGHAM, MI, 48009, US

(21) Appl. No.: 10/079,259

(22) Filed: Feb. 20, 2002

(30) Foreign Application Priority Data
Feb. 22, 2001 (DE) 101 08 527.3 42

(51) Int. Cl. B60J 7/043

(52) U.S. Cl. 296/216.01; 296/216.09

(57) ABSTRACT

Assembly as an installation element for a vehicle body, in particular as a cover for a motor vehicle sliding roof, which consists of an outer plate or cover plate preferably injection-molded from a polycarbonate, and a supporting structure for this to which the plate/cover plate is connected in a particular manner at several fixing points. As the supporting structure is formed from a material which has a co-efficient of expansion different from that of polycarbonate, at the fixing points are arranged special connecting elements which, with simple design, allow stress-compensating, direction-defined and essentially free relative movements between the supporting structure and the plate/cover plate but nonetheless hold these two components firmly and reliably together under all operating conditions.

### BACKGROUND OF THE INVENTION

The invention relates to an assembly for closing an opening in a vehicle body, in particular a cover for a motor vehicle sliding roof, which is moveably arranged in the roof opening.

Although the invention is described below using a sliding roof, assemblies structured in the same way as the cover can also be used for other locations on a vehicle body, even where the assembly firmly and immovably closes a body opening or a body surface, e.g. at window openings.

The term “sliding roof” used here alone or in combination, in the context of the present invention includes not only such constructions in which the cover, after lowering its rear edge to release the roof opening, can slide below the rear fixed roof surface, but also tilt and slide roofs in which the cover, starting from its closed position, can be swivelled about a swivel axis positioned close to its front edge in order to be moved over the fixed roof surface. Covers positionable in the same way as ventilation flaps hinged at the front, and over-ridge sliding roofs in which the cover after raising its rear edge can be slid partly above the rear fixed roof surface to release the roof opening, should also be included. Finally here too multi-cover roofs are included in which at least one cover can be moved, and roofs with removable cover or cover parts are covered by the term “sliding roof”.

### DESCRIPTION OF THE PRIOR ART

The problem of stress build-up in such assemblies due to the different co-efficients of expansion of the different materials used for components connected rigidly together is well known (e.g. DE 35 45 015 C1). Depending on temperature, these stresses can deform the assemblies (bimetal effect) so they can no longer perform their allocated task precisely at the application point. These stress concentrations can also damage or even destroy components if no stress compensation is provided.

In a known sliding roof (DE 35 45 015 C1) of the type described initially, a glass cover is provided which is connected via a peripheral adhesive layer with a supporting structure formed as a metal frame. This adhesive layer constitutes a force-fit elastic connection which allows a certain relative movement between the connected components in both vertical and horizontal direction, but in addition fixed connections are deemed necessary which are preferably provided at the four corner points. This counters the risk that the adhesive connection will separate under load under certain operating conditions.

These fixed- connections at the additional fixing points are however complex in structure because at each fixing point the cover is attached by high frequency welding or riveting to a holder element which extends through an opening in the frame and rests on this with a flange-like support surface. Thus the passage cross-section of the holder element is smaller by an amount permitting a relative horizontal movement than the cross-section of the opening, in which an additional ring can be pressed.

### SUMMARY OF THE INVENTION

The invention is based on the task of providing a cover of the type described initially for a sliding roof in which the cover plate is connected reliably under all operating conditions to the supporting structure at the fixing points, avoiding gluing of the two components, in a simple manner which nonetheless allows the required stress-compensating relative movements between the two components.

According to the present invention, there is provided an assembly for closing a roof opening in a vehicle body, in particular a cover of a motor vehicle sliding roof, which is arranged displaceably in the roof opening, the assembly including a cover plate and a supporting structure connected to the cover plate at several fixing points, wherein the fixing points allow relative movements between the cover plate and the supporting structure due to different co-efficients of expansion of the materials used for the cover plate and the supporting structure and wherein connection elements are arranged at the fixing points, which prevent relative movements between the cover plate and supporting structure substantially vertical to the cover plate but allow direction-defined and substantially free relative movements between the supporting structure and cover plate.

After assembly of the cover plate and supporting structure, the connecting elements according to the invention arranged at the fixing points allow practically no relative movement between these components vertical to the cover plate as the effects of the different co-efficients of expansion of the materials used for these components are negligible in this direction. However the connecting elements allow compensation for different expansions of the two components in directions defined by the connecting elements with essentially free relative mobility of the two components parallel to the cover plate. The cover plate and supporting structure are held together exclusively by the connecting elements without adhesive layer between these components under all operating conditions.

The invention can be used successfully with material pairings in which substantially different co-efficients of expansion apply, such as in the case of the cover plate of a thermoplastic and a supporting frame of metal plate for example steel or aluminium plate. It is of particular advantage here that, on injection molding of the cover plate, peg-like projections are formed at the same time as important constituents of the connecting elements. Because of the compensation possible according to the invention for different component dimension changes due to different co-efficients of expansion of the materials used for the cover plate and the supporting structure, in selection of the material for the supporting structure no account need be taken of the material used for the cover plate with regard to the different co-efficients of expansion. The choice of material for the supporting structure can therefore essentially be made by other criteria such as strength requirements, dimensional stability, ageing resistance and processability. The supporting structure can therefore be formed either from metal or from non-metallic materials including suitable plastics.

The cover plate can be injection-molded from a polycarbonate to achieve a substantial weight reduction in comparison with glass. Polycarbonates however are advantageous for the purposes of the invention not merely for reasons of comparatively low specific density. As thermoplastic polyesters, these polycarbonates are also colourless, transparent, temperature-resistant within broad limits, highly heat-resistant, non-toxic, non-flammable, self-extinguishing, not susceptible to scratching, have good electrical insulation, are resistant to water, mineral acids, oils, greases etc.

Further constituents of the connecting elements are slots in the supporting structure formed as a peripheral frame or consisting of individual profile rods. These slots allow the said direction-defined relative movements between the supporting structure and cover plate. Peg-like projections of the cover plate can be held in the slots of a supporting structure and the slots are aligned so that the peg-like projections have linear expansion or stress-compensating play in the longitudinal direction of the slots, but in the transverse direction of the slots however only slight movement play for relative displacement of the projections in the longitudinal direction of the slots.

The number and location of the slots in the supporting structure depend in particular on the size and construction of the cover plate and supporting structure. They should however, be arranged close to the edge of the cover plate. Thus with their longitudinal direction they are aligned about the geometric centre of the cover plate in order to achieve the desired direction-defined, stress-compensating relative movement between the cover plate and supporting structure. Preferred geometric locations for the slots are the two axes of symmetry of the approximately rectangular cover plate or the diagonal axes of the cover plate.

The constituents of the connecting elements however in addition to the peg-like projections and slots can also include clamping rings or similar, which hold the cover plate and supporting structure together in a rest position, allowing relative movement. The clamping rings are pushed clamping in the release direction, onto the peg-like projections as far as the rest position to allow relative movement at the supporting structure, after the peg-like projections have first passed through the slots.

The seal between the cover plate and the supporting structure advantageously seals the peripheral edge gap always present in sliding roof constructions. This seal can be attached to the supporting structure i.e. form part of the cover, and with a sealing surface lie sealing on the respective edge surface of the cover plate but sliding on relative movements between the cover plate and supporting structure. The said edge surface can either slope outwards while the said sealing surface slopes inwards, or the edge surface can alternatively slope inwards while the sealing surface slopes outwards.

The edge seal can be in contrast, part of the fixed vehicle roof i.e. it is not attached to the cover or its supporting structure. Here, between the cover plate and the supporting structure, a peripheral hollow profile is attached to the supporting structure which with a sealing surface lies sealing on an edge surface of the cover plate and sliding on relative movement between the cover plate and supporting structure. This hollow profile has a peripheral outer surface for resting tightly on the edge gap seal attached on the roof side at the roof opening.

### BRIEF DESCRIPTION OF THE DRAWINGS

For a better understanding of the invention and to show how the same may be carried into effect, reference will now be made, by way of example, to the accompanying drawings, in which:

FIG. 1 shows a vehicle roof in perspective view with closed cover of a sliding roof,

FIG. 2 is a cut-away section along line II-II in FIG. 1 in a first embodiment,

FIG. 3 is an enlarged view according to the extract circle III/IV in FIG. 2, where the cover plate and supporting structure are shown in a limit position of relative displaceability between these parts,

FIG. 4 is also an enlarged view corresponding to the extract circle III/IV in FIG. 2 but in another limit position,

FIG. 5 is a section similar to FIG. 2 along line II-II in FIG. 1 but in a variant of the first embodiment,

FIG. 6 is an enlarged view according to the extract circle VI/VII in FIG. 5 where the cover plate and supporting structure are shown in a limit position of relative displaceability between these parts,

FIG. 7 is also an enlarged view according to extract circle VI/VII in FIG. 5 but in another limit position,

FIG. 8 is a section similar to FIGS. 2 and 5 along line II-II in FIG. 1 in a second embodiment,

FIG. 9 is an enlarged view according to the extract circle IX/X in FIG. 8, where the cover plate and supporting structure are shown in a limit position of relative displaceability between these parts,

FIG. 10 is also an enlarged view according to extract circle IX/X in FIG. 8 but in another limit position, FIG. 11 is a diagrammatic plan view onto a partly cut-away cover with slots arranged approximately on the two axes of symmetry of the cover plate and with peg-like projections shown in cross-section,

FIG. 12 is an enlarged view according to the extract circle XII in FIG. 11,

FIG. 13 is a diagrammatic top view onto a partly cut-away cover with slots arranged approximately on the two diagonal axes of the cover plate and with peg-like projections in cross-section, and

FIG. 14 is an enlarged view according to the extract circle XIV in FIG. 13.

### DESCRIPTION OF THE PREFERRED EMBODIMENT

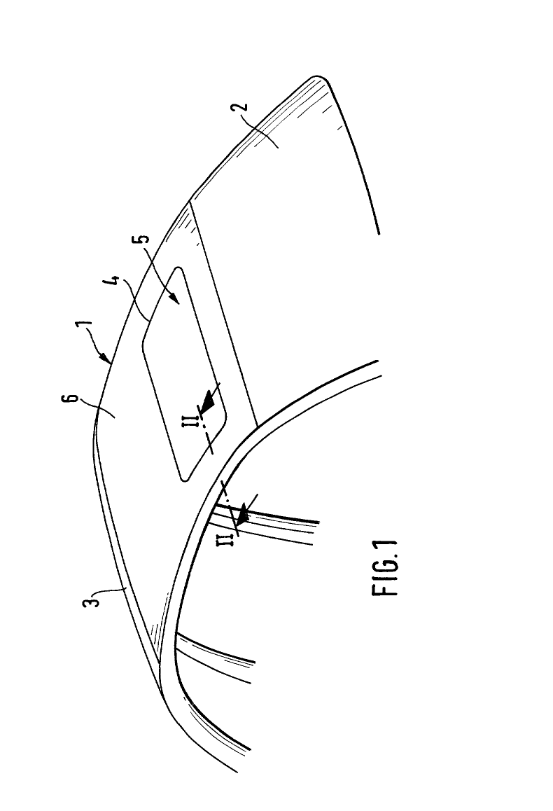

The vehicle roof 1 shown in FIG. 1 has a roof opening 4 at a smaller distance from the front screen 2 than from the rear screen 3, to which opening in the closed position is allocated a cover 5 of a sliding roof construction.

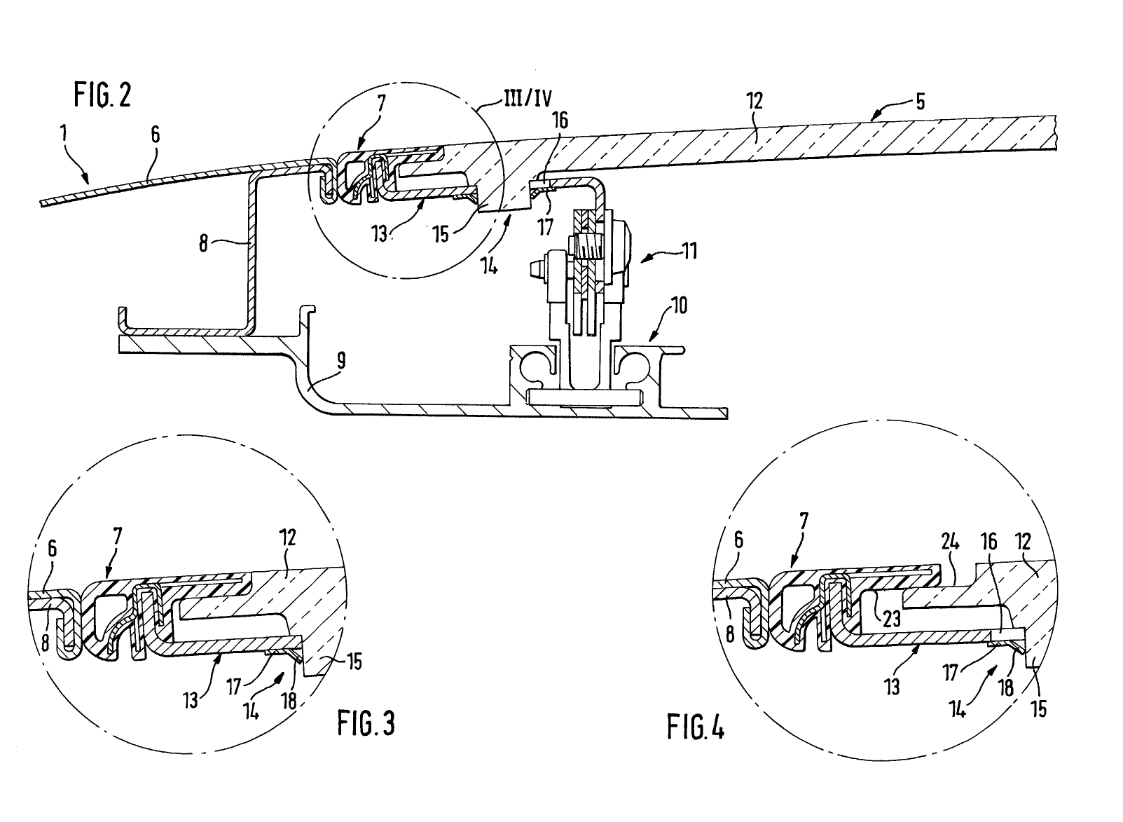

As shown in FIG. 2, the fixed roof skin 6 of the vehicle roof 1 and the cover 5 in the closed position are aligned flush with each other with regard to their outer surfaces where between them is an edge gap seal 7, which with regard to fitting and function is described in more detail below. The roof opening 4 is usually limited at the front and side by a rearwards angled chamfer of the roof skin 6, onto which is folded a reinforcement frame 8. On the reinforcement frame 8 is attached a sliding roof frame 9, on the guide rails 10 of which the cover 5 is guided displaceably at 6. Only one side the arrangement is shown, as the other cover side is designed mirror-symmetrically. The design of the cover guide, the drive and control elements for the cover 5 are not the object of the present invention and are not therefore described in more detail. The cover 5 is connected with the guide rails 10 via these elements not described here but referred to collectively as function parts 11.

The cover 5 has a cover plate 12 injection-molded from a polycarbonate and mounted on a supporting structure 13 spanning it below. The supporting structure 13 in the example shown is a peripheral frame formed from sheet metal with which the function parts 11 are connected. To compensate for temperature-dependent expansion differences between the cover plate 12 and the supporting structure 13 which occur because of the different materials of these parts, the fixing points at which these parts are connected together are structured in a particular way.

In the cross-section drawings in FIGS. 2 to 10 only one of these fixing points is shown, the other fixing points being structured accordingly. At the fixing points are provided connecting elements 14, each of which consists of a peg-like projection 15 preferably formed during injection molding of the cover plate 12 and preferably of circular cross-section, a slot 16 holding the projection 15 and a clamping ring 17.

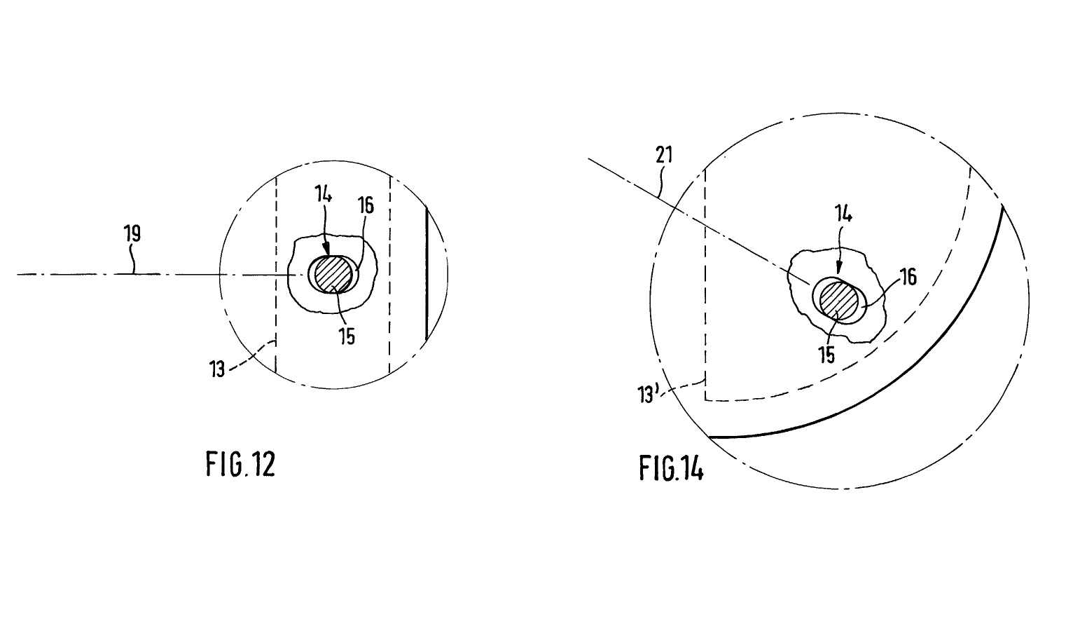

The peg-like projections 15 are held in the slots 16 with compensation play for linear expansion, but in the transverse direction however have only comparatively less movement play, as is shown most clearly in FIGS. 12 and 14. The clamping rings 17 are pushed onto the peg-like projections 15 to rest against the supporting structure 13 as is shown a from the cross-section drawings in FIGS. 2 to 10. Because of their inwardly-directed tongues 18 which bend flexibly when pushed on, the clamping rings 17 cannot simply be pushed off again in a direction opposite the push-on direction i.e. the release direction. Rather, they are clamped in a hook-like manner on the peg-like projections 15. Instead of such clamping rings 17, clips, spring clips and similar retaining elements can be used, where applicable in connection with grooves or similar applied to the projections 15.

In fitted state, the cover plate 12 and supporting structure 13 are held together by connecting elements 14, where relative movements between the cover plate 12 and supporting structure 13 and simultaneously between the supporting structure 13 and clamping ring 17 are possible parallel to the cover plate 12. This relative mobility is limited only by the length of the slots 16 as is shown by Figure pairs 3/4, 6/7 and 9/10. It will be appreciated that the length of the slots 16 is selected so that even under extreme temperatures the peg-like projections 15 do not actually reach the limit positions in the slots 16 i.e. lie against the slot ends of the projections 15, as otherwise stresses could build up between the cover plate 12 and supporting structure 13, the avoidance of which is the purpose of the invention.

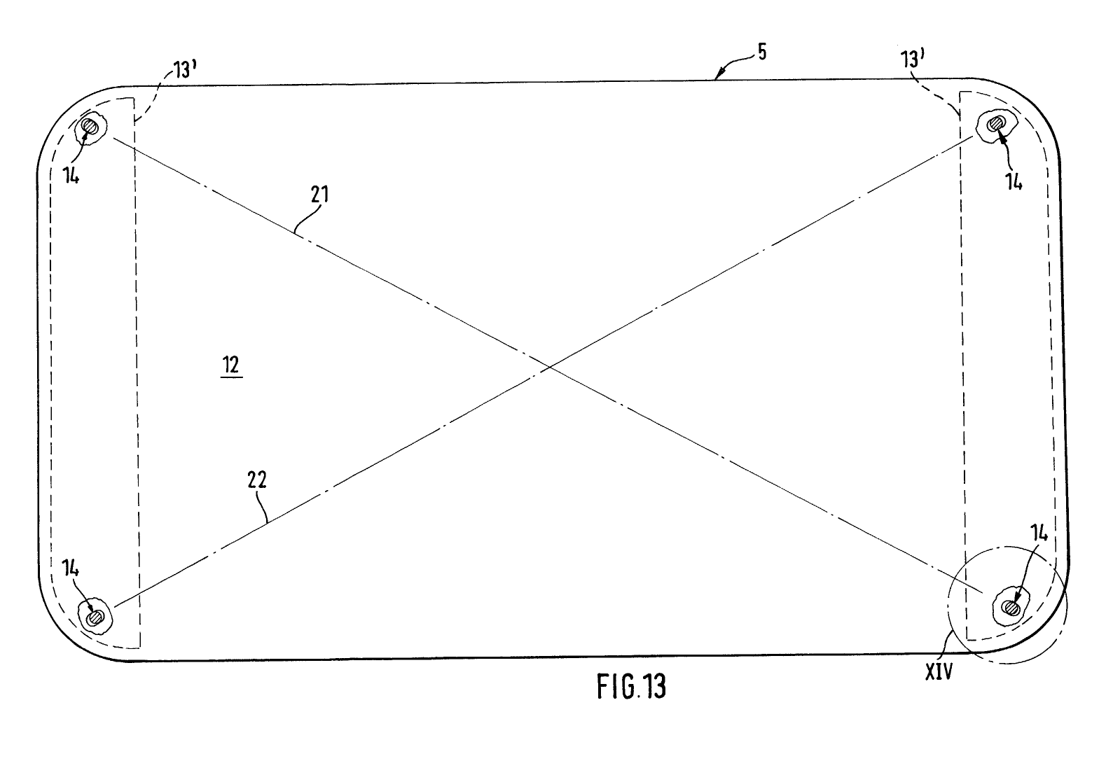

FIG. 11 shows a cover 5 to which is allocated a peripheral frame and supporting structure 13, whereas in the example in FIG. 13 profiled rods arranged on the sides of the cover 5 form the supporting structure 131. The examples of FIGS. 11 and 13 illustrate the preferred alignments of the slots 16 on the connecting elements 14, namely in FIG. 11 oriented approximately to the axes of symmetry 19, 20 and in FIG. 13 approximately to the diagonal axes 21, 22. In both cases the slots in the supporting structure 13 or 13′ are arranged close to the edge in relation to the cover plate 12. Slot arrangements according to FIG. 13 are also possible with the frame-like supporting structure according to FIG. 11. Slots 16 in all cases allow direction-defined, essentially free relative movements between the supporting structure and the cover plate.

For the seal required against the penetration of moisture between the cover plate and the supporting structure, two different embodiments are shown in the drawings. The first embodiment is shown in two variants, namely by the Figure group 2 to 4 on the one hand and Figure group 5 to 7 on the other.

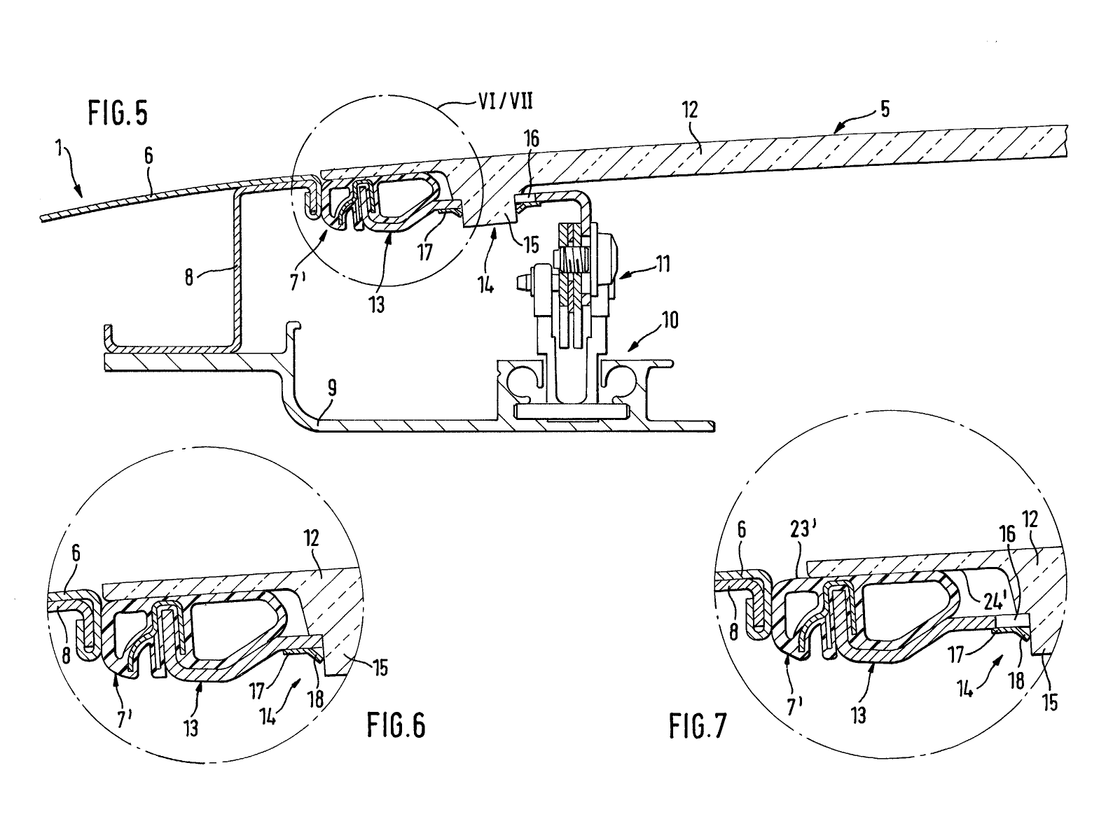

The common feature of both variants is that to seal, a peripheral edge gap seal 7 or 7′ is provided on the supporting structure 13 which lies sealing with a sealing surface 23 (FIG. 4) or 23′ (FIG. 7) on an allocated edge surface 24 or 24′ of the cover plate 12 and sliding on relative movements between the cover plate 12 and supporting structure 13. In the variant in FIGS. 2 to 4 the edge surface 24 of the cover plate 12 is however formed as an outwardly sloping stepped surface while the sealing surface 23 allocated to it is arranged sloping inward on the edge gap seal 7. In contrast in the variant in FIGS. 5 to 7 the edge surface 24′ of the cover plate 12 is formed as an inwardly sloping stepped surface whereas the sealing surface 23′ allocated to it is arranged sloping outwards on the edge gap seal 7′.

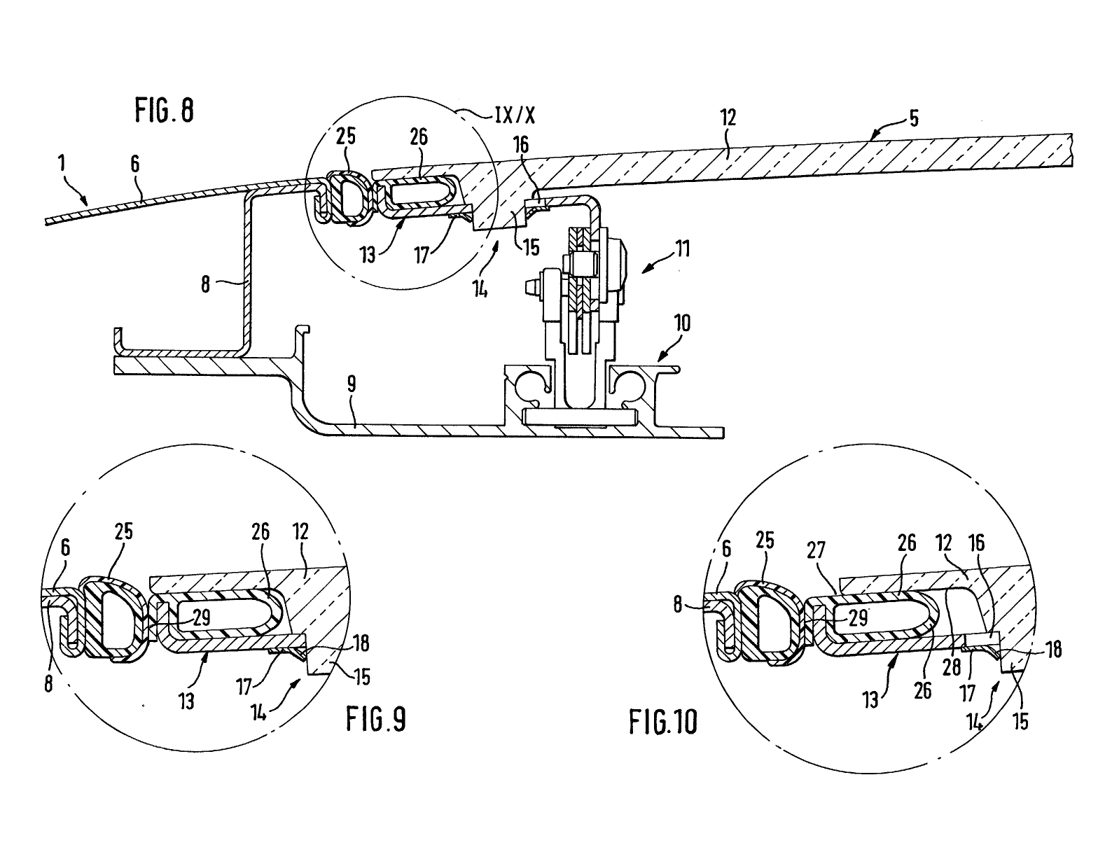

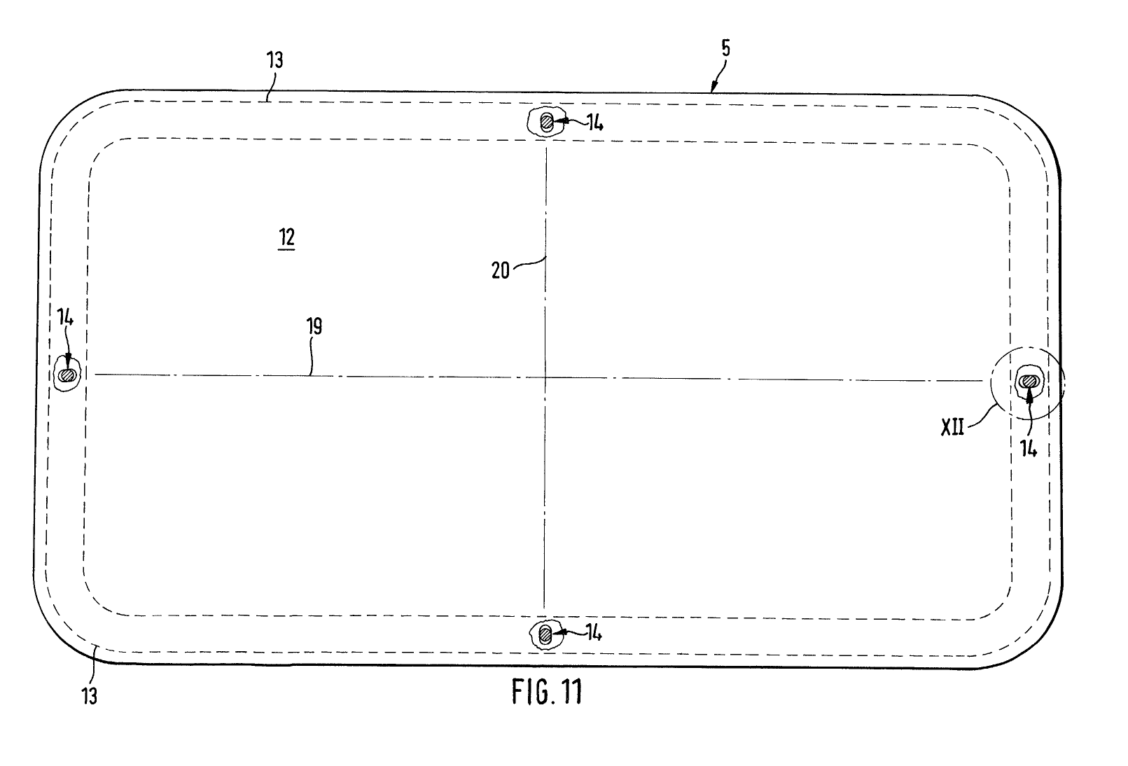

In the second embodiment shown in FIGS. 8 to 10, an edge gap seal 25 is not attached to the cover but to the edge of the fixed roof skin 6 at the roof opening. The seal between the cover plate 12 and supporting structure 13 is here provided by a peripheral hollow profile 26 attached to the supporting structure 13 and made of a suitable elastic plastic, which lies sealing with a sealing surface 27 (FIG. 10) on an edge surface 28 of the cover plate 12 and sliding on relative movements between the cover plate 12 and supporting structure 13. The hollow profile 26 has an outer surface 29 which in all possible relative positions between the cover plate 12 and supporting structure 13 projects over the outer contour of the cover 5 but at least lies approximately flush with this so that when the sliding roof is closed, the outer surface 29 lies sealed against the edge seal 25.

In summary therefore, an assembly is provided as an element of a vehicle body, in particular as a cover for a motor vehicle sliding roof, which consists of an outer or cover plate preferably injection-molded from a polycarbonate and a supporting structure supporting this which is connected in a particular manner with the plate/cover plate at several fixing points. As the supporting structure is formed of a material which has a co-efficient of expansion different from that of polycarbonate, at the fixing points are arranged special connecting elements which, with simple construction, allow stress-compensating, direction-defined and essentially free relative movements between the supporting structure and plate/cover plate but nonetheless hold these two components firmly and reliably together under all operating conditions.

I claim:

1. An assembly for closing a roof opening in a vehicle body, in particular a cover of a motor vehicle sliding roof, which is arranged displaceably in the roof opening, the assembly including a cover plate and a supporting structure connected to the cover plate at several fixing points, wherein the fixing points allow relative movements between the cover plate and the supporting structure due to different co-efficients of expansion of the materials used for the cover plate and the supporting structure and wherein connecting elements are arranged at the fixing points, which prevent relative movements between the cover plate and supporting structure substantially vertical to the cover plate but allow direction-defined and substantially free relative movements between the supporting structure and cover plate.

2. An assembly according to claim 1, wherein the cover plate is injection-molded from a thermoplastic material with simultaneous formation of peg-like projections to constitute parts of the connecting elements and wherein the supporting structure is formed from sheet metal.

3. An assembly according to claim 2, wherein the cover plate is injection-molded from a polycarbonate.

4. An assembly according to claim 1, wherein the supporting structure is in the form of a peripheral frame and is fitted at the fixing points with slots that form elements of the connecting elements.

5. An assembly according to claim 1, wherein the supporting structure consists of individual profiled rods and is fitted at the fixing points with slots that form elements of the connecting elements.

6. An assembly according to claim 1, wherein slots are provided in the supportive structure, the slots each having a longitudinal and a transverse direction and wherein peg-like projections are held in the slots of the supporting structure in such a way to provide compensation play for linear expansion in the longitudinal direction of the slots and with only movement play in the transverse direction.

7. An assembly according to claim 6, wherein the supporting structure is fitted at the fixing points with slots that form elements of the connecting elements, and wherein the slots in the supporting structure are arranged close to an edge, in relation to the cover plate and in relation to two axes of symmetry, with which the cover plate is provided and approximately on the axes of symmetry of the cover plate and parallel to these in relation to their longitudinal extension.

8. An assembly according to claim 6, wherein the supporting structure is fitted at the fixing points with slots that form elements of the connecting elements, and wherein the slots in the supporting structure are arranged close to an edge in relation to the cover plate and in relation to two diagonal axes, with which the cover plate is provided and approximately on the diagonal axes of the cover plate and parallel to these in relation to their longitudinal extension.

9. An assembly according to claim 1, wherein the cover plate is provided with peg-like projections to constitute parts of the connecting elements and wherein the cover plate and supporting structure are held together by clamping rings or the like as parts of the connecting elements in a rest position allowing relative movement, where the clamping rings or the like are pushed, clamping in the release direction, onto the peg-like projections on the cover plate up to a rest position allowing relative movement on the supporting structure.

10. An assembly according to claim 1, wherein a peripheral edge gap seal is provided to seal between the cover plate and supporting structure, the peripheral edge gap seal being attached to the supporting structure and having a sealing surface that lies in sealing relationship with an associated edge surface of the cover plate and sliding on relative movements between the cover plate and supporting structure.

11. An assembly according to claim 10, wherein the edge surface of the cover plate is formed as an outwardly sloping stepped surface, whereas the sealing surface of the edge seal is arranged sloping inwardly on the edge gap seal.

12. An assembly according to claim 10, wherein the edge surface of the cover plate is formed as an inwardly sloping stepped surface, whereas the sealing surface of the edge gap seal is arranged sloping outwardly on the edge gap seal.

13. An assembly according to claim 1, wherein, to seal between the cover plate and the supporting structure is provided a peripheral hollow profile attached to the supporting structure, which hollow profile lies sealing with a sealing surface on an edge surface of the cover plate and sliding on relative movement between the cover plate and supporting structure and which has an outer surface to rest sealing on an edge gap seal attached to the roof opening.

14. An assembly according to claim 1, wherein the cover plate is of a transparent material.

15. An assembly according to claim 1, wherein the cover plate is of a translucent material.
